(19) United States
(12) Patent Application Publication
(10) Pub. No.: US 2008/0189181 A1
(43) Pub. Date: Aug. 7, 2008

(54) Apparatus, system and method for providing digital content to customers

(76) Inventors: Ilan Zorman, Palo Alto, CA (US); Ziv Haparnas, San Francisco, CA (US)

Correspondence Address: Pearl Cohen Zedek Latzer, LLP, 1500 Broadway, 12th Floor, New York, NY, 10036, US

(21) Appl. No.: 12/068,153

(22) Filed: Feb. 4, 2008

Related U.S. Application Data
(60) Provisional application No. 60/899,482, filed on Feb. 5, 2007.

(51) Int. Cl. G06Q 30/00

(52) U.S. Cl. 705/14

(57) ABSTRACT

A system and method for providing content and advertisements to a user. Embodiments of the invention may enable an advertiser to provide content to existing customers by storing identification information on a customer's computer. The identification information may be obtained by a computer interacting with the user's computer and further used in order to identify the user and provide the user with personalized content. Other embodiments are described and claimed.

### CROSS-REFERENCE TO RELATED APPLICATIONS

The present application claims benefit of U.S. Provisional Patent Application No. 60/899,482, entitled System and Method for Companies to Advertise to Its Customers All Over the Web, and filed Feb. 5, 2007, the entirety of which is incorporated herein by reference.

### BACKGROUND OF THE INVENTION

The internet has become an essential and dominant part of the advertising industry. Substantial resources are devoted to advertisements targeted at acquiring new customers, and consequently, efficient and innovative methods have been developed towards this end. However, advertising over mediums such as the internet, television or radio may be inefficient since they lack the ability to target specific customers. Targeting existing clients or customers according to prior art, for example using direct mail and/or email are found to have limited effect and may further be regarded as too intrusive. Directed advertising in a web site owned by an advertiser is limited in the sense that a customer is required to point his or her browser to the specific web site in order to be exposed to the advertisement.

### SUMMARY OF EMBODIMENTS OF THE INVENTION

Embodiments of the invention may enable an advertiser to track known and/or existing customers and/or categories of known customers for example, when they connect to an internet site. Embodiments of the invention may further enable an advertiser to present to such customers advertisements that may be selected according to information pertaining to such customers where such information is further owned, possessed or otherwise made available by the advertiser.

According to embodiments of the invention, a cookie, tag, or any other identification parameter may be stored on a customer's computer and further communicated to a web site being viewed or interacted with by the customer. According to embodiments of the invention, an identification parameter, cookie or any other applicable tagging information may be communicated by the web site to an application that has access to an information database. For example, a database associated with a customer relationship management (CRM) application, possibly owned by the advertiser. According to embodiments of the invention, the cookie may further be used, for example, as a key to that database, in order to retrieve information associated with the specific customer. Such information may be used in order to select specific advertisements and/or other content to be presented to the customer.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary high-level diagram of exemplary components according to embodiments of the present invention;

FIGS. 2A and 2B show exemplary time-event flowcharts according to some embodiments of the invention;

FIG. 3 shows an exemplary time-event flowchart according to some embodiments of the invention;

FIG. 4 shows an exemplary high-level diagram of exemplary components according to embodiments of the present invention; and

FIG. 5 shows an exemplary time-event flowchart according to some embodiments of the invention.

It will be appreciated that for simplicity and clarity of illustration, the figures are schematic illustrations of systems arid flow diagrams, and are intended to be read with the specification for a broad understanding of the inventions of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

The term “content” or “content object” used in this patent specification should be expansively an broadly construed to include any type of digital information that may be stored, communicated, executed or otherwise manipulated by a computer. For example, content may be an application or program code, a shell, cshell or java script, a java code, or a file containing image information, multimedia information or text. The terms content and advertisement content may be used in this specification interchangeably.

The term “advertiser” as used in this patent application specification should be expansively construed to include any entity, person or body that owns and/or provides one or more items of digital advertising content for consumption by a consumer of such content. Digital advertising content, or advertisements, typically promote a commercial product or service but may also promote a non-profit cause. An advertiser may further define and provide an advertising campaign definition. A campaign definition may contain rules, policies and/or other information to accompany one or a plurality of advertisements, and that may be used for selecting the advertisements for consumption and/or the timing, context, and circumstances of their presentation. For example, a campaign may define a set of ads for consumption, a time period during which these ads are to be consumed, the order by which the ads are to be consumed, the content types with which the ads are to be associated, etc.

The terms “known user”, “existing customer”, “customer” and “user” as used in this patent application specification should be expansively construed to include any entity, body or person that has some relationship with an advertiser and for which the advertiser possibly has at least some information. For example, an existing customer of a bank may be a customer that has an account with that bank and pertaining to whom the bank may have further information. For example, information pertaining to an existing customer a bank may possess may be a customer's name, age, gender, address, credit line, balance, periodic deposits, withdrawal patterns etc. The terms “known user”, “existing customer” or simply “customer” may be used in this patent application specification interchangeably.

The term “publisher” as used in this patent application specification should be expansively construed to include any entity, body or person that publishes content and/or advertisements. A publisher may further be any entity or body that provides content and/or advertisements to content and advertisements consumers, for example, a web site may be publisher. Another example of a publisher may be a distributor of content, for example, an owner or operator of a distribution network or a content data network (CDN). An owner of a distribution network may provide content and advertisements to consumer over platforms other than web sites, for example, content and advertisements may be communicated directly to consumers.

The term “cookie” as defined by Netscape™, is “a general mechanism which server side connections (such as CGI scripts) can use to both store and retrieve information on the client side of the connection.” Accordingly, the terms “HTTP cookie”, “web cookie” or simply “cookie” as used in this patent application specification should be expansively construed to include any identification parameter, information or content that a remote computer, e.g., a server, may store on a client computer, e.g., a user computer, which the remote computer may later retrieve from the client computer, for example, later in the same session, or in a later session. Embodiments of the invention may further retrieve, extract or otherwise obtain a cookie from a computing device operated, and possibly owned, by a customer. The terms “known user”, “existing customer” or simply “customer” may be used in this patent application specification interchangeably.

The terms “internet web browser”, “web browser” or simply “browser” as used in this patent application specification should be expansively construed to include any utility, program, application or other means enabling interaction with the internet. Such interaction may comprise viewing internet web pages, downloading content, or otherwise surfing the internet. According to embodiments of the invention, a browser may further enable uploading of content, for example from a user's computer to a web site or to another computer connected to the internet.

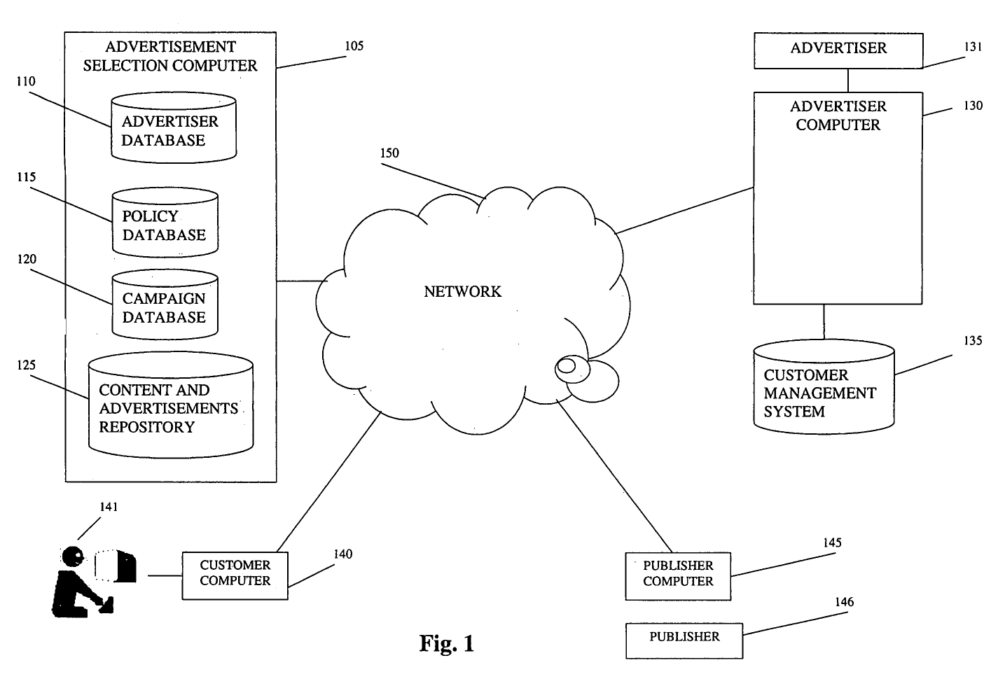

Reference is made to FIG. 1 showing an exemplary high-level diagram of a computing environment according to embodiments of the present invention. According to embodiments of the invention, customer computer 140 may be any suitable computing device capable of establishing a connection with another computer over a network. For example, customer computer 140 may be a personal computer, a desktop computer, a mobile computer, a laptop computer, a set-top box, a notebook computer, a workstation, a server computer, a tablet computer, a network appliance, personal digital assistant (PDA), mobile phone, or any other suitable computing device. According to embodiments of the invention, customer computer 140 may be owned by customer 141 or may be owned by an organization. According to embodiments of the invention, customer 141 may be any human who operates customer computer 140. According to embodiments of the invention, customer computer 140 may be operated by more than one user 141. For example, customer computer 140 may be used and/or operated by one or more family members in a home or by one or more employees in an office or other work environment.

According to embodiments of the invention, publisher computer or server 145 may be any computer capable of establishing a connection over a network. For example, publisher computer 145 may be a personal computer, a desktop computer, a mobile computer, a laptop computer, a notebook computer, a workstation, a server computer, a tablet computer, or any other suitable computing device. According to embodiments of the invention, publisher computer 145 may perform services for publisher 146. According to embodiments of the invention, publisher 146 may be any person or entity owning and/or operating publishing infrastructure such as an internet web site, television, an IPTV network or channel, an advertisement spot within a web site, an advertisement spot on an IPTV channel, an advertisement spot on television, etc. According to embodiments of the invention, publisher computer 145 may host one or more internet web sites or any other media publishing network such as TV stations or ad spot feeds, etc. Such publishing infrastructure may be maintained, managed and/or operated by publisher 146. According to embodiments of the invention, publisher computer 145 may be located in a data center, possibly owned by a hosting company or it may be located on premises belonging to publisher 146. According to embodiments of the invention, publisher computer 145 may be located in any suitable physical location where network connectivity is available. It will be recognized that according to embodiments of the invention, publisher server 145 may be a plurality of computers or servers operating together.

According to embodiments of the invention, advertiser 131 may be any person or body, such as but not limited to, an organization, an institution or agency that advertises a product, service or any other merchandise. According to embodiments of the invention, advertiser 131 may not be limited to commercial aspects of advertising. For example, advertiser 131 may be a government agency, an academic institution or a health care facility that needs and/or wants to inform various audiences or addressees of various aspects of their activities, or retrieve information from various groups or individuals with whom they are associated. According to embodiments of the invention, advertiser 131 may be in possession of information pertaining to existing customers or to associated individuals. It will be recognized that in some embodiments, advertiser 131 may not possess the information but merely have access to it, for example, through a third party on a remote site. For example, a bank may possess information pertaining to its customers or clients, such information may comprise name, age, gender, address, credit line, balance, periodic deposits, withdrawal patterns etc. Another example may be an academic institution that may possess information pertaining to students and/or staff, for example, classes, grades, tuition balance, loaned books etc.

Embodiments of the invention may enable advertiser 131 to advertise or otherwise communicate information to its existing customers, known audiences or various sets of known addressees. For example, a bank may wish to advertise a specific credit line to a group or subset of customers, where the group may be selected from the entire existing customers set. Such group may be selected according to parameters that the bank may possess, for example, age, current credit line, current balance, periodic deposits, withdrawal patterns etc. Another example may be a health care facility that may need or want to advertise or otherwise communicate information to patients or customers. For example a health care facility may want to test and/or advertise a new drug. The health care facility may further want to inform relevant patients of such drug. Accordingly, using information that the health care facility may possess, for example, medications consumed, health condition, known illnesses or diseases, the health care facility may be able, according to embodiments of the invention, to advertise the new drug to relevant patients only.

According to embodiments of the invention, advertiser computer 130 may be a personal computer, a desktop computer, a mobile computer, a laptop computer, a notebook computer, a workstation, a server computer, a tablet computer, or any other suitable computing device. According to embodiments of the invention, advertiser computer 130 may be owned or operated or otherwise managed by advertiser 131. According to embodiments of the invention, customer management system 135 may contain information pertaining to existing customers of advertiser 131. For example, customer management system 135 may be a customer relationship management (CRM) system or Sales Force Automation system or any other system that stores customer related information, or part thereof. A CRM system, as known in the art, may store various information and parameters pertaining to existing customers. According to embodiments of the invention, customer management system 135 may be owned, managed and maintained by advertiser 131.

According to embodiments of the invention, network 150 may provide an infrastructure for computer communications. For example, network 150 may comprise all or a portions of a public switched telephone network (PSTN), a public or private data network, a local area network (LAN), a metropolitan area network (MAN), a wide area network (WAN), a global computer network such as the internet, a cable or satellite TV broadcasting network, a peer to peer network, a video broadcasting network, a wireline or wireless network, a local, regional, or global communication network, an enterprise intranet, other suitable communication links, or any combination of the preceding.

According to embodiments of the invention, advertisement selection computer 105 may be any suitable computer capable of establishing a connection over network 150. For example, computer 105 may be a personal computer, a desktop computer, a mobile computer, a laptop computer, a notebook computer, a workstation, a server, e.g., a network or Internet server, a tablet computer, or any other suitable computing device. According to embodiments of the invention, computer 105 may further comprise or be operatively connected to advertiser database 110 to store advertisers information, policy database 115 to store policies information, campaign database 120 to store campaigns information and content and advertisements repository 120 to store content and advertisements. It will be understood that the databases need not be separately stored, and/or that the data referred to may be stored with additional data. According to other embodiments of the invention, more or fewer databases or other facilities may be implemented or installed in order. to store, maintain, manipulate and/or manage information such as policies, campaigns and/or advertisers and customers related information on advertisement selection computer 105. For example, a single database may be used in order to store advertisers, customers, policies and campaign information and/or parameters. It will be recognized that advertisement selection computer 105 may be a system, or a plurality of physically or geographically separated or disparate computers working together over a data network, within the scope of the present invention.

According to embodiments of the invention, campaign database 120 may enable advertisers (e.g., advertiser 131) to define and implement various advertising campaigns. Campaign database 120 may store definitions provided by advertisers and may further provide such definition, for example to an advertisement selection process. According to embodiments of the invention, a campaign may define various aspects pertaining to advertisements selections, for example, a campaign may associate specific advertisements with specific content or content types, e.g. an advertisement for a toy may be associated with content suitable for children. According to other embodiments of the invention, a campaign may be associated with a predefined set of advertisements. According to embodiments of the invention, a campaign may further define parameters such as, but not limited to, a time frame for presentation of specific advertisements, a time of day for presentation of specific advertisements, a day of a week for presentation of specific advertisements, geographic locations to be associated with various aspects of advertisements or content presentation, the number of times an advertisement is to be presented, and/or an order according to which a series or group of advertisements is to be presented. According to embodiments of the invention, campaign database 120 may be updated by an advertiser or other authorized entities. Such update may be done in order to, for example, add, delete, update or refresh campaigns, as seen necessary by, for example, an advertiser. For example, campaign database 120 may be modified according to market trends, or an affected customer set.

It will be recognized that in some embodiments of the invention, advertiser computer 130 may connect via network 150 directly to computer 105, or advertiser computer 130 may connect indirectly to computer 105, for example, via an intermediate device, such as an advertisement server or an advertisement aggregation server (not shown), which may, under certain circumstances, convey information between advertiser computer 130 and computer 105, or which may provide a connection between advertiser computer 130 and computer 105.

According to embodiments of the invention, policy database 115 may enable advertisers (e.g., advertiser 131) to define and implement various aspects pertaining to the presentation, exposure, interaction with, or any other applicable aspects pertaining to some or all advertisements in a predefined set. According to embodiments of the invention, policies may define aspects such as, but not limited to, security, authorization, and/or protection of interests of parties. For example, a policy may dictate that various content types may only be communicated over a secured (e.g. secured socket layer (SSL)) connection. Another example of a policy that may be defined may be a may be a policy that associates delivered content with computing resources. For example, such policy may prevent exhausting computing resources of a computer operated by a customer (e.g. user 141) by providing executable content that may require more than a predefined percentage of some of the computing resources available to the user.

According to embodiments of the invention, content and advertisements repository 125 may enable advertisers (e.g., advertiser 131) to provide advertisements and/or content to be delivered to their customers. According to embodiments of the invention, advertisements and/or content may be selected from advertisements and/or content in repository 120 and may further be communicated to a customer.

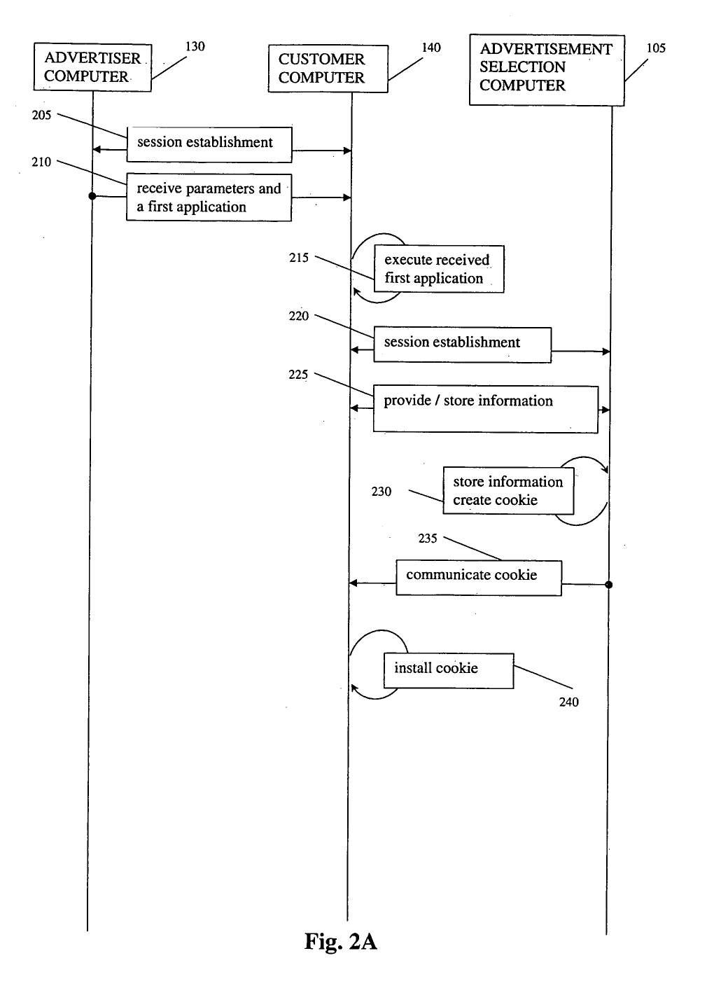

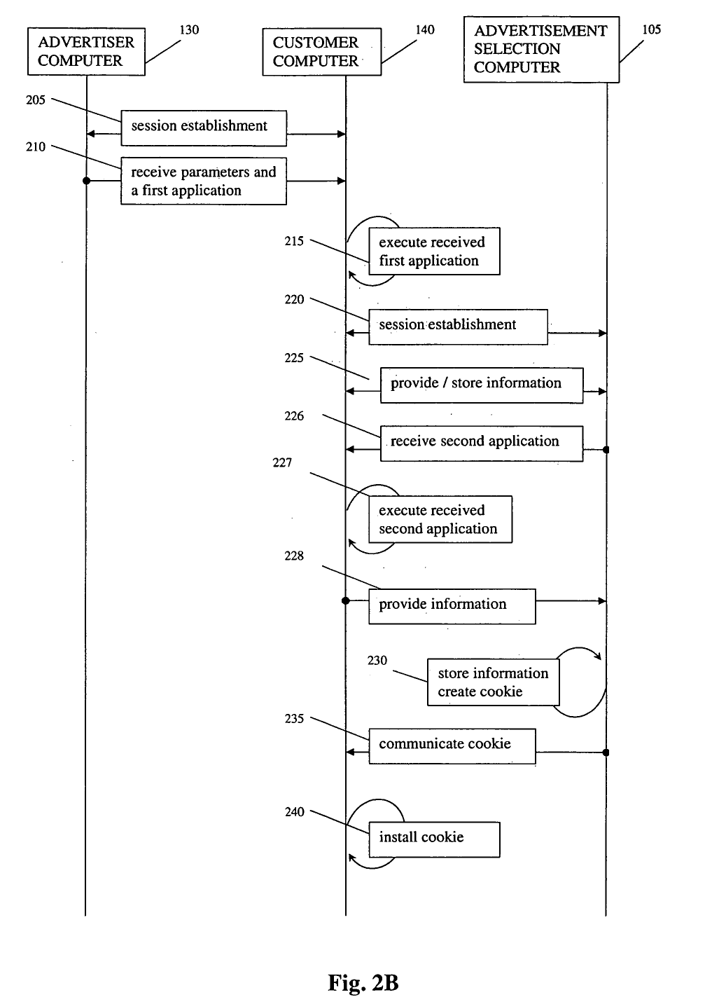

According to embodiments of the invention, a cookie or other identification means may be installed on customer computer 140. Reference is made to FIG. 2A depicting a time-event flow of a method of installing a cookie according to embodiments of the invention. According to embodiments of the invention and as shown by 205, a connection or session may be established between customer computer 140 and advertiser computer 130. For example, a customer may point the web browser at a web site hosted on advertiser computer 130, which may be associated with an advertiser, e.g., advertiser 131 in FIG. 1. According to embodiments of the invention, the session established as shown by 205 may comprise providing identification parameters by customer computer 140. For example, the customer may be an existing customer of advertiser, customer may provide a user name and password as part of the session establishment. According to embodiments of the invention, customer may be uniquely identified by advertiser computer 130, for example, a user name and password combination may uniquely identify a student establishing a session with a university's web site. Customer computer 140 may also be identified using a pre-existing identification cookie of the advertiser already resident on the computer from a previous session with advertiser computer 130. According to embodiments of the invention, based on the identification, computer 130 may have access to information pertaining to customer. For example, according to embodiments of the invention, a customer management system associated with advertiser computer 130, for example, element 135 in FIG. 1, may contain information pertaining to associated customers of the advertiser or other individuals associated with or otherwise known to the advertiser. It will be recognized that the present invention is not limited by the means of authentication used by the advertiser to identify the customer, and other means may be used, for example, contextual identification, biometric authentication, security questions, etc.

After identification of the customer, according to embodiments of the invention and as shown by 210, customer computer 140 may receive parameters and a first executable application from advertiser computer 130. According to embodiments of the invention, parameters provided to computer 140 may be parameters pertaining to the customer extracted from a customer management system and parameters pertaining to the advertiser, for example, a customer identification code and/or a parameter identifying the advertiser may be communicated to customer computer 140.

According to embodiments of the invention and as shown by 215, the first application received from advertiser computer 130 may be executed by customer computer 140. According to embodiments of the invention, such first application may be any suitable application or program, for example, the application may be a java script or a java executable code, a pearl script, a shell or cshell script or any suitable binary format executable code.

According to embodiments of the invention and as shown by 220, an execution by computer 140 of the received application may comprise establishing a session with advertisement selection computer 105. According to embodiments of the invention and as shown by 225, information may be communicated over the session created, and then stored. For example, information received from advertiser computer 130 in steps 205 and/or 210 may be communicated to advertisement selection computer 105, and stored thereon. Such information may include any applicable initialization parameters, including, for example, an identification of the advertiser by name or number, and/or a customer number of the customer in the advertiser database. Additional and other data may be used as initialization parameters. Such initialization parameters may be used by advertisement selection computer 105 in order to create a cookie as described below.

According to embodiments of the invention and as depicted by 230, advertisement selection computer 105 may use the information provided by customer computer 140 and create a cookie. The cookie may include identification of the customer using a code or number created by advertisement selection computer. Optionally, the cookie may include identification of one or more advertiser(s) to whom the customer is known. Information pertaining to the cookie, for example, its contents, its date of creation and placement on customer computer 140, and other information may be stored in a database, for example, advertiser database 110 depicted in FIG. 1. According to embodiments of the invention, the cookie may be stored in an advertisement selection memory such that an association of the cookie to one or more advertisers may be made possible. For example, a cookie may be stored in advertiser database 110 such that the cookie may be readily associated with one or more advertisers.

According to embodiments of the invention, the advertiser database 110 may store information pertaining to one or more customers of one or more advertisers. According to embodiments of the invention, information in advertiser database may be organized such that using an advertiser identification code (advertiser ID) information pertaining to customers associated with a specific advertiser may be located, retrieved, modified or otherwise manipulated. For example, all entries pertaining to customers associated with a specific advertiser may contain the advertiser ID in a predefined field. Alternatively, all entries pertaining to customers of a specific advertiser may be grouped together in a predefined location or section in advertiser database. In other embodiments of the invention, the advertiser database may be replaced by a suitable entity, such as but not limited to, table, a file, a plurality of files, a proprietary database, a commercial database, a hardware or hardware assisted module or a combination of software and hardware without departing from the scope of the invention.

According to embodiments of the invention, an advertiser may be required to provide at least two parameters in order to store information pertaining to associated customers in advertiser database. According to embodiments of the invention,.a first required parameter may be an advertiser identification code (advertiser ID). According to embodiments of the invention, an advertiser ID may uniquely identify a specific advertiser. According to embodiments of the invention, an advertiser may obtain an advertiser ID by mail, electronic mail, fax, data connection, application programming interface (API), phone or any suitable communication method. According to embodiments of the invention, a second required parameter may be a search key. As known in the art, a search key may be used in order to locate entries in a database. According to embodiments of the invention, an advertiser may define a search key by which data and/or information in advertiser database will be stored and retrieved. For example, a search key may be used in order to locate an entry associated with a specific customer in any of the databases used by or affiliated with advertisement selection computer.

According to embodiments of the invention, the cookie created may contain information pertaining to the search key value corresponding to the customer or user operating computer 140, for example, customer 141. According to embodiments of the invention, the cookie created may contain information pertaining to an advertiser ID. According to embodiments of the invention, computer 140 may store a number of cookies created as described above where each cookie may be associated with a different advertiser. According to embodiments of the invention, incorporating information pertaining to the advertiser into the cookie created, such as the advertiser ID, may enable embodiments of the invention to use a cookie created as described in order to locate information pertaining to a specific customer of a specific advertiser in database 110. In some embodiments, as described herein, the cookie may provide a unique identification of the customer, and the advertisement selection database(s) may associate the unique identification with one or more advertisers with whom the customer may be affiliated.

According to embodiments of the invention, and as depicted at 235, the cookie may be communicated to customer computer 140, and installed thereon, as depicted at 240. According to embodiments of the invention, computer 140 may store more than one such cookie of advertisement selection computer 105. For example, the flow described above may be repeated for a number of family members, or a number of customers sharing computer 140. In such case, user 141 may be, for example, the user currently logged onto computer 140. Accordingly, cookie installation as described above may be repeated resulting multiple installations of cookies on computer 140.

It will be understood that according to embodiments of the invention, advertiser may encode information and/or parameters provided to customer computer 140 such that the information and/or parameters provided may be meaningless and/or useless to any body other than the advertiser and/or advertisement selection entity. As will be described below, according to embodiments of the invention, such encoded information and/or parameters may be used by embodiments of the invention without a need and/or an attempt to decode, decipher, interpret or otherwise manipulate in an attempt to construed a meaning of such encoded information and/or parameters. According to embodiments of the invention, private, classified and/or otherwise restricted information pertaining to advertiser's customers may not be exposed to any body other than the advertiser. For example, according to embodiments of the invention, secret, confidential and/or sensitive information may only be manipulated by embodiments of the invention in encoded, encrypted or. otherwise obscured form.

It will be recognized that a cookie may be installed on customer computer 140 according to embodiments of the invention using other methods. Reference is made to FIG. 2B depicting a time-event flow of another method of installing a cookie according to embodiments of the invention. According to the embodiment depicted in FIG. 2B, the first application, when executed at 215, may be a simple application, which may simply establish the session with advertisement selection computer 105 (220), and provide certain information (225). Then, a second application may be provided by advertisement selection computer 105 to customer computer 140. According to embodiments of the invention, such second application may be any suitable application or program, for example, the application may be a java script or a java executable code, a pearl script, a shell or cshell script or any suitable binary format executable code.

According to embodiments of the invention and as shown by 227, the second application received from advertisement selection computer 105 may be executed by customer computer 140. It should be noted that an arrangement or flow as described above, namely, where a first application, when executed, fetches and executes a second application may greatly ease and improve management, maintenance and/or other aspects of embodiments of the invention. For example, relatively few computers such as advertisement selection computer 105 may support many, possibly thousands of advertiser computers such as computer 130 where these advertisers computers may in turn interact with many, possibly tens of thousands of customers such as customer 141. Installing a first application as described above, where the main task of such first application is to retrieve a second application and execute it may enable embodiments of the invention to only modify the second application when the need arises. Consequently, far less copies of a modified application need to be distributed since only computers such as computer 105 need to be updated rather than advertisers computers such as computer 130. Moreover, such arrangement may enable an administrator of computer 105 some control of the flow described, for example by customizing the second application to be provided to customer computers such as computer 140.

According to embodiments of the invention and as shown by 228, execution of the second application may comprise communicating information to advertisement selection computer 105. According to embodiments of the invention, such information may be parameters and information received by customer computer 140 from advertiser computer 130, possibly as shown by 210. For example, information communicated may be an identification of the advertiser or other information pertaining to advertiser, and/or parameters pertaining to the customer. According to embodiments of the invention, such parameters may have been provided to customer computer 140 by advertiser computer 130. Such parameters may comprise classification information and/or other information pertaining to various aspects of customer as known, viewed, or perceived by advertiser. The method may proceed with steps 230, 235 and 240 substantially as described with reference to FIG. 2A.

It will be understood with reference to both embodiments depicted in FIGS. 2A and 2B (as well as other embodiments of the invention), that an advertiser, for example, advertiser 131, may control various operational aspects and definitions of advertiser database 110. According to embodiments of the invention, an advertiser may define the content and format of customer entries in database 110 as well as define a search key by which such entries may be located. Embodiments of the invention may provide an advertiser with a set of operations that may enable an advertiser to manage information stored in advertiser database 110 and pertaining to his customers. For example, embodiments of the invention may provide operations such as, but not limited to, create an entry, update an entry, delete an entry or replace specific fields in an entry. According to embodiments of the invention, by providing an advertiser ID, a search key, customer information and further specifying an operation (e.g. create entry or update entry) an advertiser may control, manage or otherwise maintain information stored in advertiser database 110 and pertaining to his customers.

According to embodiments of the invention, storing of information may done according to a search key value provided. For example, a search key value may be provided by advertiser computer 130 to customer computer 140 as one of the parameters provided as shown by 210. According to embodiments of the invention, the search key value may further be provided to computer 105 by customer computer 140 as part of the information provided as shown by 225 and/or 228. According to embodiments of the invention, if an entry corresponding to a provided search key value already exists in advertiser database 110, then such entry may be updated with information and/or parameters provided, otherwise, embodiments of the invention may create a new entry and further populate the newly created entry with information and/or parameters provided. In some embodiments of the invention, a unique key may be created by advertisement selection computer 105 for each customer, and information pertaining to each customer may be stored in the advertisement selection database(s) based on the unique identifier, regardless of advertiser.

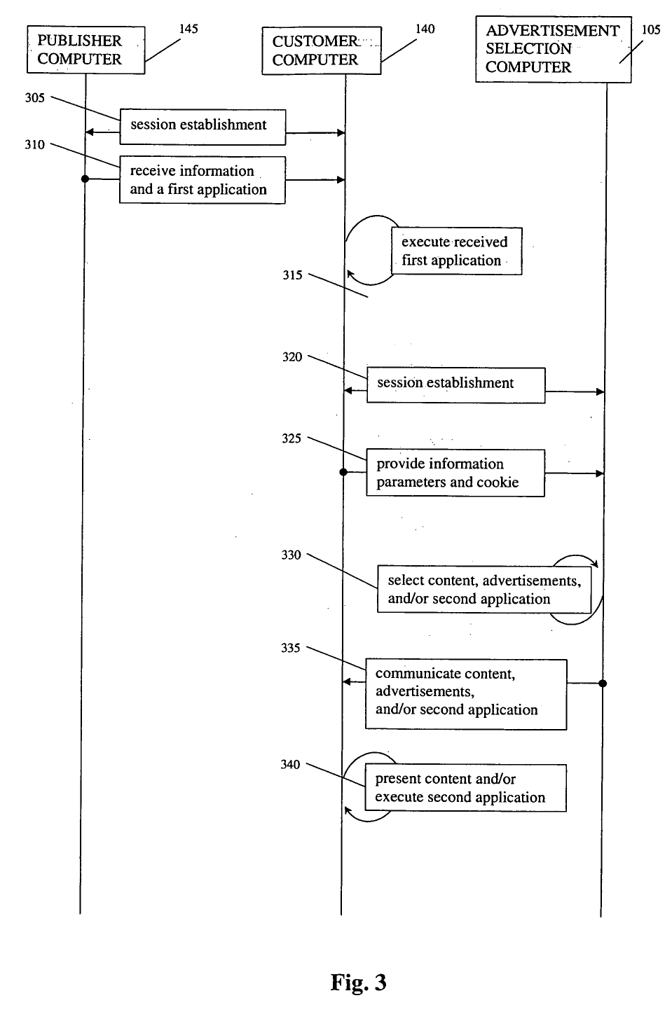

Reference is additionally made to FIG. 3 depicting a time-event flow of a method of providing content and/or advertisements to a customer and/or user according to embodiments of the invention. According to embodiments of the invention and as shown by 305, a session may be established between computer 140 and computer 145. For example, such session may be established as a result of user 141 operating computer 140 pointing his web browser to an internet site hosted by computer 145. According to embodiments of the invention, user 141 may point his browser to a site hosted by computer 145 as a result of casual web surfing or a browser operated by user 141 may establish a session with computer 145 as a result of user 141 clicking a link in a different site. According to embodiments of the invention, an internet site hosted by computer 145 may store, present or provide any type of content. For example, it may be a news site, an entertainment site, a social or gaming site. Embodiments of the invention are not restricted to aspects or attributes of the web site hosted on computer 145 such as, the content stored, presented or provide by the site, the type and/or nature of the site, a geographic location or other aspects computer 145, such as the operating system operating computer 145 or the hardware comprising computer 145. It will be noted that for purposes of simplicity, computer 140 may be referred to as customer computer, however, there is no implication or assumption that the publisher computer 145 necessarily knows, determines or otherwise acts on the basis of computer 140 being a customer of an advertiser. As explained below, publisher computer 145 may send the first application to all computers 140, or selectively only to some computers 145, for example, based on identification information stored on computer 140.

According to embodiments of the invention, such internet site may be operated, maintained and/or owned by publisher 146 and the user operating computer 140 may further be an existing customer of advertiser 131.

According to embodiments of the invention and as shown by 310, the flow may comprise communication of information between computer 140 and computer 145. According to embodiments of the invention, such information may comprise an identification of publisher 146. For example, a unique publisher identification code assigned to publisher 146 may be communicated to computer 140. Such identification may be used in order to associate content and/or advertisements delivery to user 140 with publisher 146, for example, in cases where publisher 146 may be paid according to a number of advertisements presented to user 140 as a result of a flow that begun by user 140 visiting a web site operated by publisher 146. According to embodiments of the invention, other information may be communicated to computer 140 from computer 145. For example, information pertaining to the content of the site and/or page being viewed by user 140 may be communicated. Such information may be used, as will be described later, in order to select one or more advertisements and/or content objects to present to user 140 with the pages being viewed. According to embodiments of the invention, any other available and/or applicable information may be-communicated from computer 145 to computer 140 as shown by 310.

According to embodiments of the invention and as further shown by 310, a first application may be communicated from publisher computer 145 to customer computer 140. Such application may be a java script or a java executable code, a pearl script, a shell or cshell script or any suitable binary format executable code, program or application. According to embodiments of the invention, such communication may be executed without an intervention or even knowledge of user 140, for example, a java code may be embedded in one or more pages comprising a web site hosted on computer 145. When such pages are retrieved by a browser operated by user 140 the java code may be retrieved with the page it is embedded in and may further be executed, for example, by the retrieving browser. According to embodiments of the invention and as shown by 315, the first application received by computer 140 may be executed by computer 140. For example, the first application may be a java script or java application retrieved with the by a browser on computer 140 and may further be executed by the receiving a browser.

According to embodiments of the invention and as shown by 320, an execution of the application received by computer 140 may comprise establishing a session with computer 105. According to embodiments of the invention and as shown by 325, information and/or parameters may be communicated over the session established as shown by 320. According to embodiments of the invention, the information provided by computer 140 to computer 105 may comprise any or all the information received by computer 140 from computer 145, such as, but not limited to, an identification code of advertiser 146, information pertaining to the page viewed by user 140 and possibly other information pertaining to user 140 that may have been collected by computer 145, for example, information pertaining to activities or interactions of user 140 associated with the site containing the page viewed. In addition, a customer identifier, for example, a cookie previously placed on customer computer 140 by advertisement selection computer may be sent to advertisement selection computer. For example, the identification may be in the form of a cookie previously placed on customer computer 140 as described, for example in FIG. 2A or 2B or otherwise.

According to embodiments of the invention, some of the information communicated by computer 140 to computer 105 may originate from computer 140. For example, formatting information that may be used by computer 105 in order to select content to be rendered on a display of computer 140 may be provided to computer 105, e.g. a size of a display connected to computer 140 or a pixel resolution parameter of a display connected to computer 140 may be communicated. Another type of information that may be conveyed may be a browser type used by user 140 or availability of various software and/or hardware resources on computer 140 etc. According to embodiments of the invention and as further shown by 325, a cookie may be communicated from computer 140 to computer 105. According to embodiments of the invention, such cookie may have been installed on computer 140 as described above with reference to FIG. 1.

According to embodiments of the invention and as shown by 330, content and/or advertisements may selected by computer 105. According to embodiments of the invention, such content and/or advertisements may be embedded in an application. For example, the content selected may be embedded in, or comprise of, a java application or code. According to embodiments of the invention and as shown by 335, content and/or advertisements selected may be communicated by computer 105 to computer 140. According to embodiments of the invention and as shown by 340, communicated content may be provided to a consumer of the content (e.g. customer 141 in FIG. 1). According to embodiments of the invention, providing the content may comprise executing an executable program, code, script or application. For example, the content selected and provided as described above may be a java script provided to a browser operated by a user, consequently, the browser may execute the script which in turn may present the content to the user.

According to embodiments of the invention and as described above, an advertiser may define aspects such as, but not limited to, the structure, fields, format, content and encoding of customers entries in database 110. Accordingly, an advertiser may encode or otherwise represent parameters, data and/or any other applicable information pertaining to his customers in advertiser database 110. For example, a bank utilizing embodiments of the invention may define that a customer entry in advertiser database 110 will comprise six fields as follows: a first field to be used as a search key, a second field to reflect customer age, a third field to reflect customer gender, a fourth field to reflect a balance, a fifth field to reflect periodic deposits and a sixth field to reflect withdrawal patterns.

For example, the bank may use an internal identification code associated with a customer as the first (search key) field. The bank may further assign the following values to the second (age) field: A to denote customers who are under twenty years old, B to denote customers between twenty and forty five years old and C to denote all other ages. The bank may further assign the following values to the third (gender) field: A to denote a female, B to denote a male. According to embodiments of the invention, the forth field (balance) may contain the following values: A for a customer who's balance has not been under $1000 in the past six months, B for a customer who's balance has been above $1000 and below $10,000 in the past six months and C for the rest. The fifth field (periodic deposits) may contain the following values: A for customers who deposit money no more than once a month, B for all other customers, and the sixth field (withdrawal patterns) may be contain the following values: A for a customer who withdraw money from his account no more than twice a month, B for all other customers.

Accordingly, an entry in advertiser database 110 such as XBACBB may reflect a customer who's identification code is X, who is between twenty and forty five years old, is a female, who's balance has been above $10,000 in the past six months, who deposits money more than once a month and further withdraws money from her account more than twice a month. Referring to the example above, the bank may define various rules, policies and/or campaigns using entries as described. For example, a campaign may define that various advertisements or content will be provided to female customers who are under twenty years old, while another campaign may be directed at customers who are males over forty five years old and who further have had a balance of more than $10,000 in the past six months.

It should be noted that according to embodiments of the invention, any other applicable information may be encoded into entries in advertiser database 110, the format, number, meaning, encoding or any other applicable aspects of fields comprising such entries may be different from those described in the example above, and more or fewer entries comprising a single entry may be defined and implemented. Such alterations may be defined and/or implemented without departing from the scope of the present invention.

According to embodiments of the invention, selecting content and/or advertisements to be provided to a customer, for example, as sown by 330 in FIG. 3, may comprise applying one or more policy definitions and/or rules and one or more campaign definitions and/or rules. According to embodiments of the invention, an advertiser may define a number of customer categories and further associate one or more campaigns with such categories. For example, an academic institution may define a first category that includes all second year students who are taking history as part of their current year program and a second category that includes third year students who attend a specific literature seminar. According to embodiments of the invention and as described above, such categories may be reflected in advertiser database 110 by encoding information such as classes attended in current year and number of years studied in fields comprising a customer, or in this case, a student entry.

According to embodiments of the invention, a first campaign aimed at promoting a specific history book may be launched by the academic institution and may further be associated with the first defined category while a second campaign aimed at informing students of external literature classes may be defined and associated with the second category. Accordingly, a student included in the first category described above may operate computer 140 and may further, while surfing the internet, connect to computer 145, where computer 145 may host a gaming site. According to embodiments of the invention, an advertisement or information pertaining to the above mentioned specific history book may be presented to such student. Accordingly, a student belonging to the second category described above may surf to the same gaming site hosted on computer 145 but be presented with information pertaining to external literature classes.

According to embodiments of the invention, selecting content and/or advertisements as shown by 330 in FIG. 3 may further involve various aspects, information and/or parameters pertaining to the site being viewed and/or interacted with by the user. According to embodiments of the invention, such information and/or parameters may be communicated from a publisher site to the user's computer, for example, as part of the information communicated as shown by 310 in FIG. 3. According to embodiments of the invention, such information and/or parameters may further be communicated from a user's computer to computer 105, for example, as part of the information communicated as shown by 325 in FIG. 3. According to embodiments of the invention, the type or nature of the site as well as the type and nature of the content being viewed or interacted with may effect content and/or advertisements selection as shown by 330 in FIG. 3.

For example, if the site being interacted with by user 141 is a gaming site then an advertisement for computer games may be selected as shown by 330 and further communicated to computer 140 as shown by 335. Alternatively, if user 141 is interacting with a site hosted on computer 145 where the site provides a platform for various internet forums, and user 141 is further participating in a gardening forum then information provided to computer 105 as described above may enable embodiments of the invention to select an advertisement for flower seeds to be presented to user 141 in such scenario. It should be noted that, according to embodiments of the invention, various considerations and/or parameters used for selecting an advertisement such as, for example, policies, campaigns, user profiles, and/or site information are by no means mutual exclusive, but rather, may be used in conjunction. According to embodiments of the invention, policy definitions may be used in order to resolve contradicting advertisements and/or content selection parameters or results.

According to embodiments of the invention, a user or customer profile may be maintained and may further be used by an advertisement and/or content selection process as shown by 330 in FIG. 3. According to embodiments of the invention, customers profiles may be stored separately or may be incorporated into one or more databases described above, for example, user's profiles may be incorporated into advertiser database 110. According to embodiments of the invention, interaction of a user with content provided as shown by 335 and 340 in FIG. 3 may be tracked and recorded. Accordingly, embodiments of the invention may deduce preferences, patterns and/or other aspects of a user's interaction with content and/or advertisements. Such information may further be used by embodiments of the invention in a content selection process such as the one shown by 330 in FIG. 3.

The ability of embodiments of the invention to identify and track specific, individual users combined with ability of embodiments of the invention to select specific advertisements and/or content for specific, individual users may enable embodiments of the invention to support complex and highly efficient campaign definitions. For example, by tracking the number of times an advertisement was presented to a customer, embodiments of the invention may allow an advertiser to define the number of times a first advertisement will be presented to a customer before a second one is presented. According to embodiments of the invention, such series of advertisements may be provided to a user by more than one internet site, namely, a first advertisement may be provided from a first site, a second advertisement from a second site and so on. Although presentation of advertisements and/or content may be performed in association with, possibly random, surfing the internet and, accordingly, in association with different internet sites, embodiments of the invention may enable support of campaigns and/or policies under such conditions and/or scenarios.

According to embodiments of the invention, selection of advertisements and/or content to be presented to a customer may be contextual. For example, embodiments of the invention may keep track of sites interacted with by a user, accordingly, advertisements and/or content selection may take such surfing history information into account, for example, user preferences, interests, frame of mind and/or taste may be deduced by considering sites visited and such deduction may be taken into account by a content selection process.

According to embodiments of the invention, selection of advertisements and/or content to be presented to a customer as shown by 330 in FIG. 3 may be based, to some degree, on a bidding. For example, two or more advertisers may compete for an advertising spot in a web page. In such case, embodiments of the invention may employ further considerations, for example, select the advertisement of the advertiser willing to pay the highest price. Consequently, embodiments of the invention may provide a platform for bidding for advertisements spots, time, or other applicable means of exposure.

According to embodiments of the invention, information pertaining to a publisher may be collected and may further be communicated to an advertiser. For example, a publisher may be paid by an advertiser according to a number of advertisements or amount of content presented to customers. Information pertaining to a publisher may be communicated from a publisher's computer (e.g. computer 145) to a user's computer (e.g. computer 140), for example, such information may be communicated as shown by 310 in FIG. 3. Such information may further be communicated to computer 105 as shown by 325 in FIG. 3. The information may further be communicated from computer 105 to an advertiser's computer, e.g. computer 130 in FIG. 1. According to embodiments of the invention, information pertaining to a publisher as described may be accompanied by information pertaining to the content or advertisement that was provided to a customer by the publisher. Other information provided to the advertiser may be the specific site the customer was interacting with, a time and date, length of page view, click through to a landing page, signup information, and/or any applicable information that may be obtained.

It will be understood that the embodiment described with reference to FIG. 3 is merely one of many embodiments possible incorporating the present invention. In some embodiments of the invention, publisher computer 145 may send the first application (330) selectively to users that it knows have customer affiliations with advertisers, as described above. For example, publisher may have a cookie on the customer computer, or publisher may read the cookie set on customer computer by advertisement selection computer.

In other embodiments of the invention, publisher computer 145 may send the first application (330) to all users. Therefore, in such embodiment, upon execution of the first application (315), advertisement selection computer 105 may optionally determine whether customer computer 140 has stored on it a cookie or other identifying information that establishes that information pertaining to the customer is available to advertisement selection computer, for example, stored on advertisement selection databases. If so, the method may proceed to select and send content, etc. as described above. If the user has no customer affiliations with advertisers served by the advertisement selection computer, any of several actions are possible. For example, any random advertisement may be provided the advertisement selection computer may establish a connection with an external advertisement server to provide an advertisement; or one of the advertisers' advertisements, for example, one directed at non-customers, may be provided to customer computer.

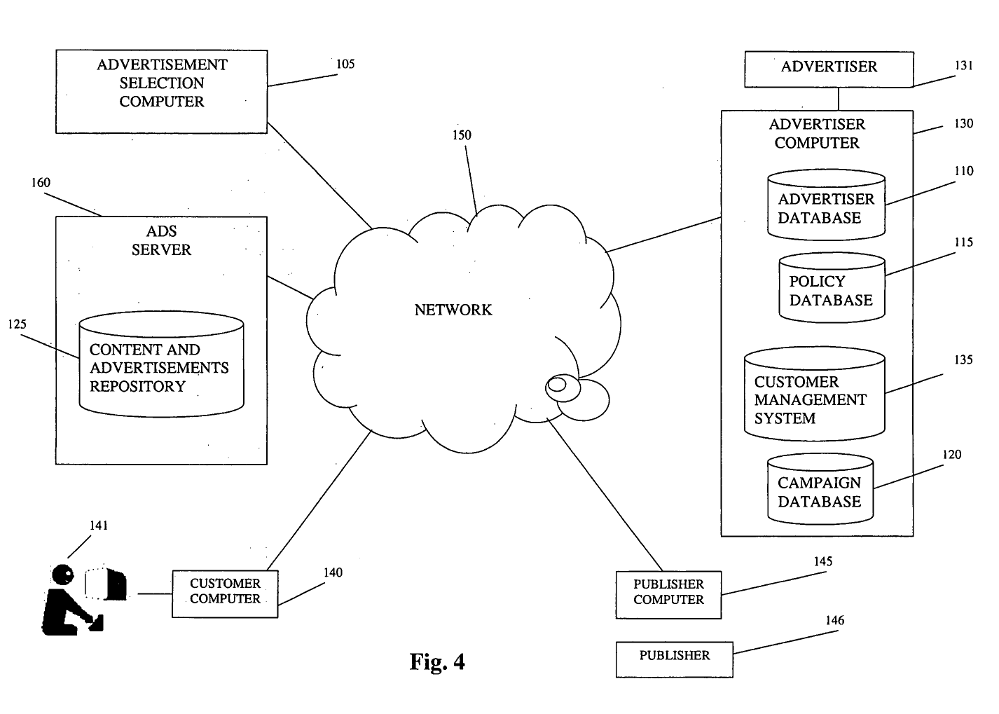

According to embodiments of the invention, various components, procedures, logic or information may be distributed over a number of computing devices. For example, information and information management systems, such as, databases 110, 115, 120 and repository 125 may be connected to, hosted by, or otherwise distributed among computers other than computer 105. Reference is made to FIG. 4 showing an exemplary alternative distribution of components according to some embodiments of the present invention. As shown in FIG. 4 and according to embodiments of the invention, advertiser computer 130 may comprise, or host, databases 110, 115 and 120. According to embodiments of the invention, and as further shown in FIG. 4, content and advertisement repository 125 may be connected to, or hosted by, ads server 160. According to embodiments of the invention, advertisement server (ads server) 160 may be a computer, normally operated by a third party, that may deliver and track advertisements independent of the web site where the ads are being displayed. Use of an ads server such as ads server 160 may, among other things, help establish trust between an advertiser (e.g. advertiser 131) and publisher (e.g. publisher 146) since the statistics are maintained by a well known, objective third party, namely, the operator of the ads server. Ads server 160 may manage and maintain advertisements such as, for example, ad banners for a web site or collection of web sites. According to embodiments of the invention, ads server 160 may further determine which ads to serve based on parameters such as priority, campaign definitions and/or rules, price, bidding etc. Ads server 160 may also be responsible for managing a campaigns, tracking and/or reporting on impression delivery and/or click-thru rates.

It will be noted that, according to embodiments of the invention, other distributions of various components, procedures, logic or information may be possible, for example, ads server 160 may host additional databases, for example, one or more of databases 110, 115 and 120. Further more, some components may be logically, physically and/or operationally combined. For example, according to embodiments of the invention, advertiser database 110 may be combined with customer management 135 and policy database 115 may be combined with campaign database 120. It should be noted that alternative distributions, arrangements, combinations and/or modifications such as described above may be made without departing from the scope of the present invention.

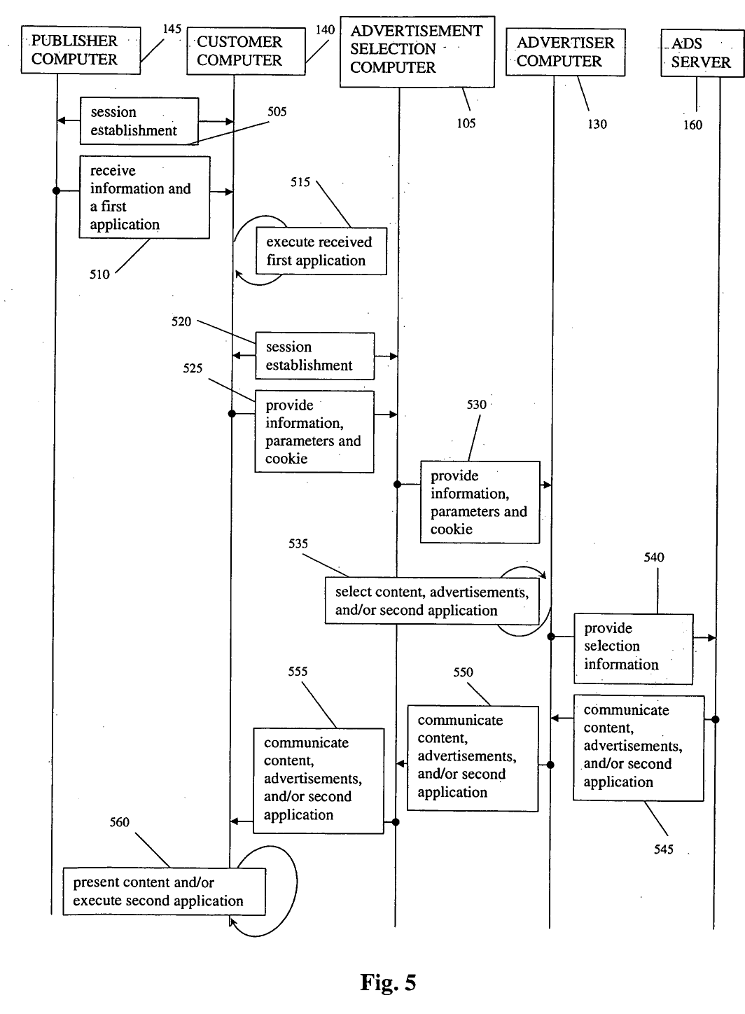

Reference is made to FIG. 5 depicting a time-event flow of a method of providing content and/or advertisements to a customer and/or user according to embodiments of the invention. It will be noted that the flow presented in FIG. 5 is best viewed or followed with reference to FIG. 4. According to embodiments of the invention and as shown by 505, a session may be established between computer 140 and computer 145. For example, such session may be established as a result of user 141 operating computer 140 pointing his web browser to an internet site hosted by computer 145. According to embodiments of the invention, user 141 may point his browser to a site hosted by computer 145 as a result of casual web surfing or a browser operated by user 141 may establish a session with computer 145 as a result of user 141 clicking a link in a different site. According to embodiments of the invention, an internet site hosted by computer 145 may store, present or provide any type of content. For example, it may be a news site, an entertainment site, a social or gaming site. Embodiments of the invention are not restricted to aspects or attributes of the web site hosted on computer 145 such as, the content stored, presented or provide by the site, the type and/or nature of the site, a geographic location or other aspects pertaining to computer 145, such as the operating system operating computer 145 or the hardware comprising computer 145. According to embodiments of the invention, such internet site may be operated, maintained and/or owned by publisher 146 and the user operating computer 140 may further be an existing customer of advertiser 131.

According to embodiments of the invention and as shown by 510, the flow may comprise communication of information between computer 140 and computer 145. According to embodiments of the invention, such information may comprise an identification of publisher 146. For example, a unique publisher identification code assigned to publisher 146 may be communicated to computer 140. Such identification may be used in order to associate content and/or advertisements delivery to user 140 with publisher 146, for example, in cases where publisher 146 may be paid according to a number of advertisements presented to user 140 as a result of a flow that began by user 140 visiting a web site operated by publisher 146. According to embodiments of the invention, other information may be communicated to computer 140 from computer 145. For example, information pertaining to the content of the site and/or page being viewed by user 140 may be communicated. Such information may be used, as will be described later, in order to select one or more advertisements and/or content objects to present to user 140 with the pages being viewed. According to embodiments of the invention, any other available and/or applicable information may be communicated from computer 145 to computer 140 as shown by 310.

According to embodiments of the invention and as further shown by 510, a first application may be communicated from computer 145 to computer 140. Such application may be a java script or a java executable code, a pearl script, a shell or cshell script or any suitable binary format executable code, program or application. According to embodiments of the invention, such communication may be executed without an intervention or even knowledge of user 140, for example, a java code may be embedded in one or more pages comprising a web site hosted on computer 145. When such pages are retrieved by a browser operated by user 140 the java code may be retrieved with the page it is embedded in and may further be executed, for example, by the retrieving browser. According to embodiments of the invention and as shown by 515, the first application received by computer 140 may be executed by computer 140. For example, the first application may be a java script or java application retrieved with the by a browser on computer 140 and may further be executed by the receiving a browser.

According to embodiments of the invention and as shown by 520, an execution of the application received by computer 140 may comprise establishing a session with computer 105. According to embodiments of the invention and as shown by 525, information and/or parameters may be communicated over the session established as shown by 520. According to embodiments of the invention, the information provided by computer 140 to computer 105 may comprise any or all the information received by computer 140 from computer 145, such as, but not limited to, an identification code of advertiser 146, information pertaining to the page viewed by user 140 and possibly other information pertaining to user 140 that may have been collected by computer 145, for example, information pertaining to activities or interactions of user 140 associated with the site containing the page viewed.

According to embodiments of the invention, some of the information communicated by computer 140 to computer 105 may originate from computer 140. For example, formatting information that may be used by computer 105 in order to select content to be rendered on a display of computer 140 may be provided to computer 105, e.g. a size of a display connected to computer 140 or a pixel resolution parameter of a display connected to computer 140 may be communicated. Another type of information that may be conveyed may be a browser type used by user 140 or availability of various software and/or hardware resources on computer 140 etc. According to embodiments of the invention and as further shown by 525, a cookie may be communicated from computer 140 to computer 105. According to embodiments of the invention, such cookie may have been installed on computer 140 as described above with reference to FIG. 1.

According to embodiments of the invention and as shown by 530, information, parameters and the cookie provided to computer 105 by customer computer 140 may further be communicated from computer 105 to advertiser computer 130. According to embodiments of the invention, computer 105 may select the advertiser to which information will be communicated as shown by 530. For example, computer 105 may select the advertisers according to various parameters and/or information such as a price each potential advertiser is willing to pay for presenting an advertisement to user 141. According to embodiments of the invention, computer 105 may provide a platform for bidding for advertisements presentation to customers. According to embodiments of the invention, various algorithms and/or logics may be employed by computer 105 as part of the advertiser selection process, for example, a round robin algorithm may select an advertiser, or a service level agreement (SLA) may be adhered, e.g., select an advertiser a predefined number of times per day or hour. It will be noted that any mechanism, algorithm, logic, method or other means for selecting an advertiser may be employed without departing from the scope of the present invention.

According to embodiments of the invention, although not shown in FIG. 5, instead of communicating information to advertiser computer 130, computer 105 may communicate an application to computer 140. According to embodiments of the invention, such application, when executed by computer 140, may establish a session between computer 140 and advertiser computer 130 and may further communicate information, parameters and/or a cookie to advertiser computer 130. Such information may be used by advertiser computer 130 in order to select content and/or advertisements. According to embodiments of the invention, advertiser computer 130 may further communicate the selected content and/or advertisements to computer 140 where such content and/or advertisements may be presented to user 141.

According to embodiments of the invention and as shown by 535, advertiser computer 130 may select content and/or advertisements to be presented to customer 141. According to embodiments of the invention, such content and/or advertisements may be an application. For example, the content selected may be embedded in, or comprise of, a java application or code. According to embodiments of the invention, computer 130 may perform such selection in accordance with information, parameters, definitions and/or rules that may be defined, stored in, and/or provided by one or more systems such as, advertiser database 110, policy database 115, campaign database 120 and/or customer management system 135. Selection of content and/or advertisements as shown by 535 may further be as described above with reference to 330 in FIG. 3. It should be noted that, according to embodiments of the invention, the selection process described above and shown by 535 may be performed by a computer other than computer 105. For example, according to embodiments of the invention, ads server 160 may be provided with the information provided to computer 105 as shown by 530 and may further perform the selection described above. In such case, some or all of databases 110, 115, 120 may be accessible to ads server 160 or they may be operatively connected to ads server 160. For example, such databases may be physically connected to ads server 160 or ads server 160 may otherwise manage and/or maintain these databases.

According to embodiments of the invention and as shown by 540, advertiser computer may communicate information pertaining to content and/or advertisements selection to ads server 160. According to embodiments of the invention, such information may include a specific selection of a specific content object or advertisement or it may provide information that may be used by ads server 160 in order to select a content object or an advertisement. According to embodiments of the invention and as shown by 545, ads server may communicate a selected content object or advertisement to advertiser computer 130. According to embodiments of the invention, such content or advertisements may be retrieved from content and advertisements repository 125. According to other embodiments of the invention, such content or advertisements may be retrieved by ads server 160 from another computer (not shown), possibly over a network connection. According to embodiments of the invention and as shown by 550, advertiser computer 130 may communicate the content and/or advertisements to computer 105 that may further communicate the content and/or advertisements to computer 140 as shown by 555, possibly over the session established as shown by 520. According to embodiments of the invention and as shown by 560, computer 140 may present and/or provide the content received to user 141.

According to embodiments of the invention, user 141 may be provided with an option to gate, approve, disapprove, opt-in, opt-out, or otherwise provide embodiments of the invention with feedback regarding content and/or advertisements presented. According to embodiments of the invention, such feedback may be recorded by embodiments of the invention and may further be taken into account, for example in a selection process described above. According to embodiments of the invention, user 141 may be provided with an option to block specific content and/or advertisements. Alternatively, user 141 may be provided with an option to block various types, groups, sets, categories or other classifications of content and/or advertisements. According to embodiments of the invention, content and/or advertisements presented to a customer may comprise or otherwise be associated with executable code, program or application that may enable a user to provide her feedback. For example, a couple of thumbs-up/thumbs-down buttons may be displayed near, over, along side or in any other position or grades of transparency, such that their association or relevance to a specific content and/or advertisements is clear. According to embodiments of the invention, by pressing the thumbs-up button a user may indicate to embodiments of the invention approval of the relevant content or advertisements. Accordingly, by pressing the thumbs-down button a user may indicate to embodiments of the invention disapproval of the relevant content or advertisements. Another example of a possible interaction method may be a pull down menu that may be associated with content presented to a user, where such pull down menu may provide a user with various feedback options, e.g. “block content of this type”, “provide more content of this type”, etc.

According to embodiments of the invention, feedback provided by a user as described above may comprise various parameters, preferences, restrictions and/or any other applicable information. According to embodiments of the invention, a content and/or advertisement selection process may be provided with, or readily access information pertaining to the user, the site the user is currently interacting with, the current time, day and date, various statistics, and the publisher. Accordingly, complex rules, preferences, policies and constraints may be supported by embodiments of the invention. For example, embodiments of the invention may enable a user to provide time related preferences, e.g. by providing a button that reads “don't present such content from 09:00 to 17:00”, or site related constraints such as “don't display such content in association with this site”.

Feedback from a customer may be stored by embodiments of the invention, for example, in advertiser database 110. According to embodiments of the invention, information in a feedback from a user may be encoded into a user entry described above. According to embodiments of the invention and as described above, feedback information contained in a user entry in advertiser database 110 may be used by a content and/or advertisement selection process as described above. According to embodiments of the invention, information provided from a user as described may be stored, possibly with other information, in a user profile. Such user profile may be part of, for example, advertiser database 110, or it may be stored separately, or incorporated into other information repositories or databases, for example, customer management system 135.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A system comprising:
an advertisement selection computer capable of communicating over a network with a customer computer, wherein in a first session said advertisement selection computer is to:
receive from said customer computer an initialization parameter, said initialization parameter relating to an advertiser,
store in an advertisement selection memory an association between an identification parameter and said advertiser, and
cause to be stored in a memory associated with said customer computer said identification parameter; and
wherein in a second session, subsequent to said first session, said advertisement selection computer is to:
receive from said customer computer said identification parameter,
select at least one advertiser associated with said identification parameter, and
cause to be provided to said customer computer at least one content object associated with said advertiser.

2. The system of claim 1, wherein said advertisement selection computer is further to:
store information associated with said customer computer, and
select said at least one-content object based at least in part on said information associated with said customer computer.

3. The system of claim 2, wherein said information associated with said customer computer comprises feedback received from said customer computer.

4. The system of claim 3, wherein said feedback received from said customer computer indicates a lack of interest by a user in presented content.

5. The system of claim 3, wherein said feedback received from said customer computer indicates approval by a user of presented content.

6. The system of claim 2, wherein said information associated with said customer computer comprises a number of times a content object has previously been provided to said customer computer.

7. The system of claim 1, wherein at least one content object is an application, wherein said application, when executed on said customer computer, retrieves digital content from a remote computer.

8. The system of claim 1, wherein said advertisement selection computer is further to receive said at least one content object from a remote computer.

9. The system of claim 1, wherein said advertisement selection computer is further to receive from said customer computer information pertaining to an advertisement spot and is further to select at least one content object to fill said advertisement spot.

10. The system of claim 1, wherein said advertisement selection computer is further configured to store a plurality of advertisement campaign definitions, and wherein said advertisement selection computer is to select said at least one content object based, at least in part, on at least one of said plurality of advertisement campaign definitions.

11. The system of claim 1, wherein said advertisement selection computer is further to store information associated with said customer computer, and to communicate said information to a remote computer, wherein said remote computer is to select said at least one content object to be provided to said customer computer.

12. The system of claim 1, wherein said identification parameter is a cookie.

13. The system of claim 1, wherein said identification parameter is associated with a plurality of advertisers, and wherein said at least one content object is selected based on a bidding process among said plurality of advertisers.

14. A method comprising:
in a first session between an advertisement selection computer system and a customer computer:
receiving from said customer computer an initialization parameter, said initialization parameter relating to an advertiser,
storing an association between an identification parameter and said advertiser, and
causing to be stored in a memory associated with said customer computer said identification parameter; and
in a second session between said advertisement selection computer system and
said customer computer, subsequent to said first session:
receiving from said customer computer said identification parameter,
selecting at least one advertiser associated with said identification parameter, and
causing to be provided to said customer computer a content object associated with said advertiser.

15. The method of 14, further comprising in said second session between said advertisement selection computer system and said customer computer:
communicating said identification parameter to an advertiser server, and
receiving an identification of a content object from said advertiser, wherein said step of causing to be provided comprises causing said identified content object to be provided to said customer computer.

16. The method of 14, wherein if said identification parameter is associated with a plurality of advertisers, then selecting at least one advertiser associated with said identification parameter comprises selecting one of said plurality of advertisers based on a bidding process among said advertisers.

17. The method of 14, further comprising:
storing at least one customer parameter associated with said identification parameter; and
selecting said content object to be provided to said customer computer based on an application of an advertisement selection policy to said at least one customer parameter.

18. The method of claim 17, wherein said at least one parameter associated with said identification parameter comprises feedback received from a user associated with said identification parameter.

19. The method of claim 18, wherein said feedback received from said user indicates a lack of interest by said user in presented content.

20. The method of claim 18, wherein said feedback received from said user indicates approval by said user of presented content.

21. The method of claim 17, wherein said customer parameter comprises a number of times a content object has previously been presented to said user.

22. The method of claim 17, wherein said selecting said content object is according to at least one of a plurality of advertisement campaign definitions.

23. The method of claim 14, wherein said identification parameter is a cookie.

24. The method of claim 17, wherein said selecting said content object is further according to a bidding process involving a plurality of advertisers.
